(19) United States
(12) Patent Application Publication
(10) Pub. No.: US 2008/0135647 A1
(43) Pub. Date: Jun. 12, 2008

(54) Drip Irrigation Devices

(76) Inventors: Mykel France, Salt Lake City, UT (US); F. Benjamin Nishiguchi, Bountiful, UT (US); E. Tres Wangsgaard, Salt Lake City, UT (US)

Correspondence Address: Kirton & McConkie;1800 Eagle Gate Tower, 60 East South Temple, P.O. Box 45120, Salt Lake City, UT, 84145-0120, US

(21) Appl. No.: 11/609,757

(22) Filed: Dec. 12, 2006

(51) Int. Cl. A01G 25/02

(52) U.S. Cl. 239/542

(57) ABSTRACT

Drip irrigation devices and the associated methods for making and using such devices for irrigation are described. The devices can be attached to a plant container or pot, typically on the edge and/or not in the soil, so as not to impede the plant's root structure or the soil configuration. The devices receive fluid from an external fluid distribution mechanism and then apply the fluid to the plant or soil using an internal distribution mechanism. The drip irrigation devices can be configured with at least one member to hold, stabilize, or balance the irrigation device on the desired surface of the container. The devices can also contain with an internal or external flow controller to regulate the flow of the fluid to the container.

### FIELD

The present application relates, in general, to irrigation devices. In particular, the present application related to drip irrigation devices and associated methods for making and using such drip devices for irrigation.

### BACKGROUND

The use of irrigation devices in home, gardens, small farms, and greenhouses is widely accepted for liquid, chemical and nutrient distribution to greenhouse planters and containers. Some of these devices are often used to deliver small amounts of fluid and so are often called drip irrigation devices, i.e., since the fluid delivery is so slow that the fluid is distributed by a dripping motion.

Some of these drip irrigation devices are often manually operated. In other words, they need to be held or operated by a person while they deliver the fluid to the desired location. These devices, therefore, require a large amount of manual labor which increases the cost of operation. And since they do not operate automatically, they can not be used when the operator is not present, i.e., they can not be used in a home when the home owner is on vacation.

Other drip irrigation devices, however, are not manually operated. But some of these types of devices are aesthetically unpleasant so that they are not used in greenhouses and customers do not incorporate them into their homes and gardens. Other types of these drip-irrigation devices have a reservoir of water, but are placed in the soil near the plant and are bulky and obtrusive. Accordingly, they can obstruct a plant's root system and can also diminish the view of the plants because of the space needed for the reservoir. Thus, many of the non-manual drip irrigation devices have not been widely adopted.

### SUMMARY

The present application relates to drip irrigation devices and the associated methods for making and using such devices for irrigation. The devices can be attached to a plant container or pot, typically on the edge and/or not in the soil, so as not to impede the plant's root structure or the soil configuration. The devices receive fluid from an external fluid distribution mechanism and then apply the fluid to the plant or soil using an internal distribution mechanism. The drip irrigation devices can be configured with at least one member to hold, stabilize, or balance the irrigation device on the desired surface of the container. The devices can also contain with an internal or external flow controller to regulate the flow of the fluid to the container.

### BRIEF DESCRIPTION OF THE DRAWINGS

The following description can be better understood in light of Figures, in which:

FIG. 1 illustrates one example of an irrigation system containing a drip irrigation device;

FIG. 2 depicts a side view of one example of a drip irrigation device; and

FIG. 3 illustrates a top view of another example of a drip irrigation device.

Together with the following description, the Figures demonstrate and explain the principles of the irrigation devices and associated methods for using the devices. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the devices and associated methods of using the devices can be implemented and used without employing these specific details. Indeed, the devices and associated methods can be placed into practice by modifying the illustrated devices and can be used in conjunction with any devices and techniques conventionally used in the industry. For example, while the description below focuses on drip irrigation devices used with isolated pots or plant containers, these devices may be implemented in many other applications and end uses, such as with a series of such containers or in any irrigation system.

The irrigation devices can be used to irrigate plants without being placed in the soils where the plants are located. Typically, but not exclusively, the devices are placed on the container in which the plant is located. Any device that operates in this manner can be used, including the devices described and illustrated below.

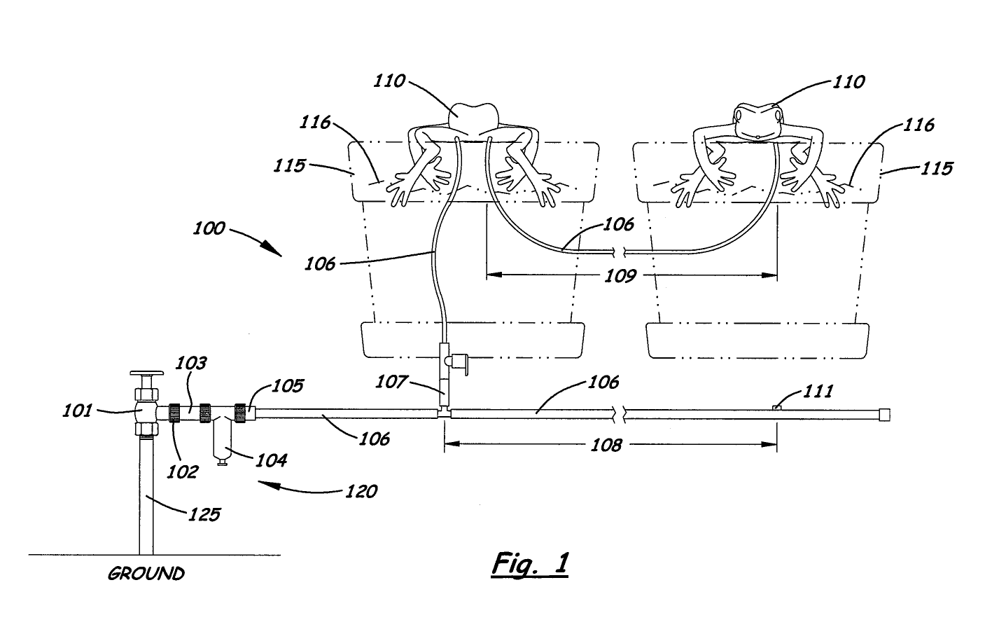

FIG. 1 illustrates one view of the drip irrigation device in a typical drip irrigation system 100. The drip irrigation system 100 delivers the desired fluid (typically water) from a fluid source 125, through a fluid delivery mechanism 120, to drip device 110 on container 115 (which typically contains a plant or anything else that needs the fluid). In certain instances, some of the components of the system are hidden from view by, for example, placing them behind walls in conduits (like electrical systems in a house) or by burying them underneath the soil.

The fluid source 125 can be any known reservoir for the desired fluid. For example, where the fluid is water, the fluid source can be water from a pipe, a hose, or any other known water source. The fluid source can be either a single source or a plurality of sources.

The system 100 also contains any known mechanism for delivering the fluid from the fluid source to the drip irrigation device 110. In some instances, the delivery mechanism 120 contains a valve 101 that provides access to the fluid source 125. The valve 101 may be any known valve, including automatic or manual valves, off-the-shelf or custom valves, and may also include an anti-siphon mechanism.

The fluid delivery mechanism 120 can also contain any known backflow preventer 102 that prevents any debris or contaminants form working their way back into the fluid source 125. The fluid delivery mechanism can also contain any known pressure regulator 103 to regulate the fluid flow and control it to the desired rate. The fluid delivery mechanism can also contain any known filter 105 to prevent particulates and debris from entering and potentially clogging the drip irrigation system 100.

In certain instances, the irrigation system can also contain an access port 104. The access port 104 can be used for any reason, such as to measure or test the fluid flowing through the system 100. In certain instances, an additional nutrient (both solids and/or fluids) for the plant can be added to the fluid though the access port 104. The access port 104 can also be used for any other purpose known in the art.

The fluid delivery mechanism 120 also contains any known piping or tubing 106 through which the fluid flows. In some instances, the tubing 106 can be made of polyethylene and is easily shaped and manipulated for proper placement of the components of the system 100. In other instances, the tubing (or portions thereof) can be made of copper pipe, rigid or flexible PVC pipe, polybutylene, cross-linked polyethylene, or any similar material.

The fluid delivery mechanism 120 delivers the fluid to the drip device 110. The drip device 110 then delivers the fluid at any desired rate to a plant in the container 115. The drip device can be typically located on any desired location of the container 115 which can irrigate the plant without interfering with the root growth or visibility of the plant. One such location includes resting on the edge of the container above the plant. Another such location includes any location that is not on the plant or in the soil 116 of the container, including on fixtures on or above the container 115.

In some aspects, the system 100 can contain more than one drip device for a single container, for example, by using two drip devices for a single container. In other aspects, the system 100 can contain a single device that is configured to irrigate more than a single container. In yet other aspects, the system 100 contain two or more drip devices that are respectively used for two or more containers by using a “T” fitting 107 to divert the fluid from a first drip device located on a first container and then to a second drip device located on a second container and separated from the first device by a distance 109. Of course, flow of the fluid could be reversed and directed to the second drip device and then to the first drip device by moving the “T” fitting to the location 111 in the fluid delivery system.

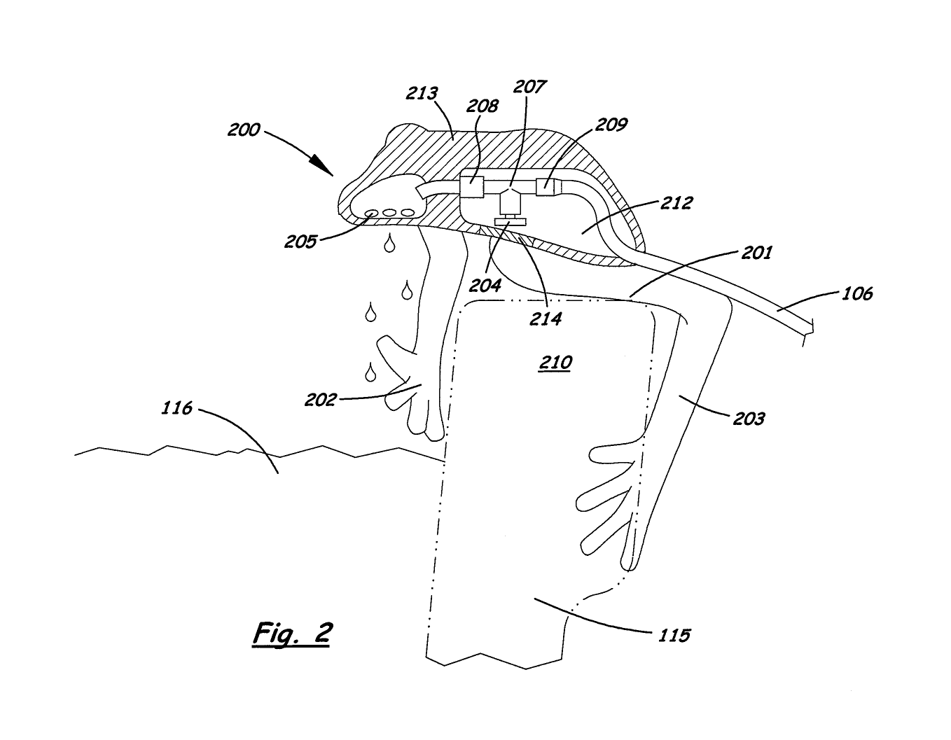

FIG. 2 shows a detailed view of a drip device 200 that can also be used in the system 100. The drip device 200 can be any desired shape or size that depends on the desired end use of the drip device. Typically, the size of the drip device can be configured to be similar to the container with which the drip device will be associated.

The drip device 200 can be given any desired shape that still allows it to operate as described herein. In some instances, thought, the drip device can be given any aesthetically pleasing shape. Examples of such shapes include animals (like frogs, geckos, lizards, toads, insects, or birds), plants (like flowers, trees, or bushes), art, people, sculptures, statues, geometric shapes, creatures (like fairies, elves, gnomes, or hobbits), or any combination thereof.

The drip device 200 contains a body 213 with the shape and size described above. The drip device 200 can also contain a cavity 212 in which can be contained any number of control components for the fluid. Examples of the control components include a dispenser 208, a valve 207, an attachment mechanism 209 for securing tubing 106, and a flow controller 204. As well, the drip device 200 can contain any components known in the art, including a mechanism to tubing clamp to secure the tubing to a barbed fitting, a tubing to hose fitting, or even a pipe thread adapted fitting.

The valve 207 can be any valve known in the art that can fit within the drip device 200 given its size and shape. Examples of valves that can be used include ball valves or “T” valves. The tubing attachment mechanism can be any known in the art that will secure tubing 106 relative to the body 213.

The flow controller 204 can be used to control the flow rate of the fluid being dispensed from the container. Any known flow controller in the art can be used. The flow controller can be an adjustable flow controller that allows a user to adjust the flow to any desired rate. As well, the flow controller can be a fixed rate controller, such as an orifice.

The flow controller 204 can be configured to be externally accessible by a user by providing an opening (such as a hatch 214) in the body 213. The flow controller 204 may then be accessed by hand or by any available tool to adjust the controller. Additionally, the controller could be remotely controlled or wirelessly controlled, or in some embodiments even hard wired.

Because the purpose of the drip device 200 is to deliver a fluid to the plant, the dispenser 208 of the drip device can be configured in any manner that irrigates the soil or plant as desired. While only one dispenser 208 is depicted in FIG. 2, the drip device 200 could be configured with any number (or types) of dispensers.

In some instances, the dispenser 208 may contain holes 205 that are placed so that the fluid can be applied directly to the soil 116 (or other contents) of the container 210. Alternatively, the dispenser 208 could be attached to a mini sprayer (not shown) to distribute the fluid by mist or spray. Indeed, the dispenser could comprise any orifice or nozzle for any type of desired spray pattern.

The drip device 200 could contain any other mechanism that would allow the fluid to be distributed to the soil at the desired flow rate (anywhere from a steady stream to a small drip). The flow rate at which the fluid can be distributed can depend on any desired parameter, including the nutritional needs of the plant. In some instances, the flow rate can range from a very slow drip to a constant stream of fluid. In other instances, the flow rate can range a moderate drip to a fast drip.

The drip device 200 also contains a plurality of members 201, 202, 203 that can be used to hold, stabilize, and/or balance the drip device on the container. These members are not always needed since the drip device can be affixed to the container in any desired location by any known means such as a clamp or any similar mechanism. In most instances, though, the drip device is removably attached to the container so that it can be moved from location to location. In these instances, the members are used to hold the drip device in the desired location, as well as in certain instances stabilize or balance, the device on the container 115. In other instances, though, the drip device can be attached by using an adhesive.

In the embodiments depicted in FIG. 2, the members 201, 202, 203 can rest respectively on the interior and exterior of the container's edge 210. Any (or all) of the plurality of members may be adjustable in any direction to allow the device 200 to be securely held on the container's edge 210. As well, the any (or all) of the plurality of members may be adjustable in any direction to allow the device to be stabilized at the location of the container at which it is placed.

As well, the members can be used to balance the drip device 200 on the desired location of the container, such as edge 210. In these situations, one member 201 can rest parallel and atop the container's surface and act as a balancing member. The balancing member 201 contacts the surface by making full contact or may be formed so that it contacts the container's surface at a plurality of points.

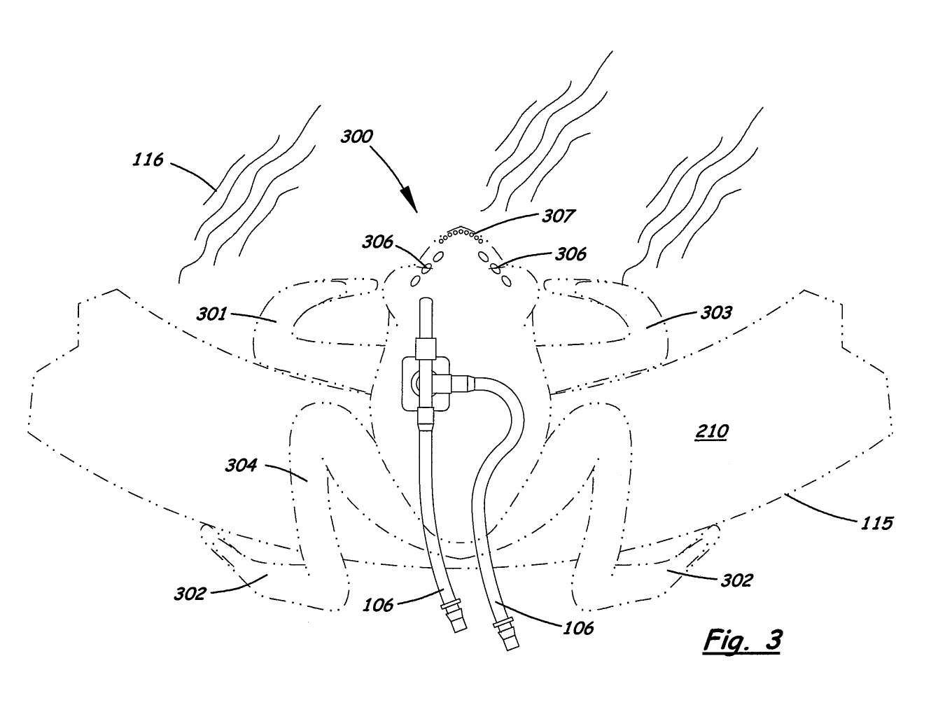

FIG. 3 represents a top view of another drip device 300. In FIG. 3, the drip device 300 is depicted as a frog. In FIG. 3, the members 301, 302 and 303 are used as stabilizing members and are separate from the member 304 that is used as a balancing member. The balancing member 304 in FIG. 3 is represented by a pad or foot of the frog that rests on the surface of the container 210. The cavity of the drip device 300 in FIG. 3 houses similar components to those described in FIG. 2, including a flow controller with an internal or external control access (not shown).

The drip device 300 may also have a distribution mechanism, i.e., holes 306 for dripping or a grille 307 for spraying. As with the device of FIG. 2, the device 300 of FIG. 3 also distributes the fluid to the soil (or other contents of the containers) and can, if desired, avoid the container's wall. If necessary, though, the drip device can be used to distribute fluid on the container's walls. As well, the drip device can be configured so that the fluid is distributed directly to any location of the plant.

The irrigation devices described above can be made by any known process that provides them with the components and configurations described above. In certain embodiments, the drip devices are made by providing the internal components and then providing the outer body. When sold as part of an irrigation system (such as illustrated in FIG. 1), the drip device can be manufactured so that it fits with, and functions with, the remainder of the components of the system.

The irrigation devices described above can be used to irrigate any desired container(s) to which they are connected. As well, they can be configured to irrigate any desired location in the container, such as any location on the plant, as well as any location in the soil. As well, the drip devices can be used to irrigate any other location outside of the container, such as any soil in which the container rests. The devices described above can be operated either manually, automatically, or semi-automatically as desired.

The irrigation devices are referred to as drip devices because the dripping motion used to distribute the fluid. But they can be used to distribute the fluid in any other manner, such as spraying or misting. As well, any other low-flow distribution methods can be used.

The devices and methods described above have several advantages. First, because they can be placed on the container rather than the soil, they do not interfere with a plant's root system. Second, since they are not placed in the soil, they do not obstruct the view of the plant or flower in the container. Third, they can be configured to be aesthetically pleasing. Fourth, since they can be configured to operate automatically, they can be used when a user is not present.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. An irrigation device for low flow distribution of a fluid, comprising:
a decorative body containing a fluid dispenser that is in fluid communication with and is supplied with fluid from a fluid source external to the decorative body; and
apparatus for attaching the body to a container.

2. The device of claim 1, wherein the container contains a substance that needs to be irrigated.

3. The device of claim 2, wherein the device does not contact the substance which it is irrigating.

4. The device of claim 1, wherein the fluid dispenser is located within the decorative body.

5. The device of claim 4, where the decorative body also contains an internal controller for controlling the flow rate of the fluid.

6. The device of claim 1, wherein the attachment apparatus comprises at least one member for holding, stabilizing, or balancing the irrigation device on the container.

7. The device of claim 6, wherein the attachment apparatus secures the decorative body to the edge of the container.

8. The device of claim 1, Wherein the attachment apparatus is part of the decorative body and is configured to be aesthetically pleasing.

9. The device of claim 6, wherein one member is used to balance the decorative body and another member is used to stabilize the decorative body.

10. The device of claim 4, wherein the decorative body can be adjusted to dispense fluid to any desired location.

11. A drip irrigation device, comprising:
a decorative body containing an internal fluid dispenser that is in fluid communication with and is supplied with fluid from a fluid source external to the body; and
apparatus for attaching the decorative body to the edge of a container containing a plant in soil.

12. The device of claim 11, wherein the device does not contact the soil.

13. The device of claim 11, wherein the decorative body also contains an internal controller for controlling the flow rate of the fluid.

14. The device of claim 11, wherein the attachment apparatus comprises at least one member for holding, stabilizing, or balancing the irrigation device on the container.

15. The device of claim 14, wherein one member is used to balance the decorative body and another member is used to stabilize the decorative body.

16. The device of claim 11, wherein the attachment apparatus is part of the decorative body and is configured to be aesthetically pleasing.

17. An irrigation system, comprising:
a fluid source; and
a drip irrigation device comprising: a decorative body containing an internal fluid dispenser that is in fluid communication with and is supplied with fluid from the fluid source that is external to the body; and apparatus for attaching the decorative body to the edge of a container containing a plant in soil.

18. The system of claim 17, wherein the decorative body also contains an internal controller for controlling the flow rate of the fluid.

19. The system of claim 17, wherein the attachment apparatus comprises at least one member for stabilizing or balancing the irrigation device on the container.

20. The system of claim 17, wherein the attachment apparatus is part of the decorative body and is configured to be aesthetically pleasing.

21. A method for making a drip irrigation device, comprising:
providing a decorative body containing an internal fluid dispenser that is in fluid communication with and is supplied with fluid from a fluid source external to the body; and
providing an apparatus for attaching the body to a container.

22. The method of claim 21, further comprising providing the decorative body with an internal controller for controlling the flow rate of the fluid.

23. The method of claim 21, further comprising providing the attachment apparatus with at least one member for stabilizing or balancing the irrigation device on the container, providing the attachment apparatus as part of decorative body, and configuring the attachment apparatus to be aesthetically pleasing.

24-26. (canceled)

27. A drip irrigation device, comprising:
a decorative body containing an internal fluid dispenser that is in fluid communication with and is supplied with fluid from a fluid source external to the body and an internal controller for controlling the flow rate of the fluid; and
an aesthetically-pleasing apparatus for attaching the decorative body to the edge of a container containing a plant in soil.

28. The device of claim 27, wherein the attachment apparatus comprises at least one member for holding, stabilizing, or balancing the irrigation device on the container.

29. The device of claim 28, wherein one member is used to balance the decorative body and another member is used to stabilize the decorative body.
